(19) United States
(12) Patent Application Publication
(10) Pub. No.: US 2001/0053218 A1
(43) Pub. Date: Dec. 20, 2001

(54) Transaction bridging/forwarding in signaling system of telecommunications network

(76) Inventors: Alex Leung, Eatontown, NJ (US); Mark A. Ratcliffe, Oakhurst, NJ (US)

Correspondence Address: BANNER & WITCOFF LTD.,, ATTORNEYS FOR AT & T CORP, 1001 G STREET , N.W., ELEVENTH STREET, WASHINGTON, DC, 20001-4597, US

(21) Appl. No.: 09/934,543

(22) Filed: Aug. 23, 2001

Related U.S. Application Data
(63) Continuation of application No. 09/320,344, filed on May 26, 1999.

(51) Int. Cl. H04M 7/00

(52) U.S. Cl. 379/221.08; 379/229

(57) ABSTRACT

A “TC Correlate” mechanism correlates the outgoing TC-dialogue of an originating signaling point (SP) with the outgoing TC-dialogue at an intermediate SP. It allows an intermediate SP to terminate its TC-dialogue (signaling transaction) after it is no longer needed from a functional standpoint, while preserving end-to-end TCAP connectivity. It also allows an intermediate signaling point (e.g., switch or database) to forward a query to a second signaling point (e.g., second switch or database), while otherwise staying out of the TC-dialogue. In both instances, greater efficiency and better use of network resources can be achieved.

### BACKGROUND OF TIE INVENTION

The present invention relates to telecommunications networks, and particularly to methods for establishing communication links between nodes in a common channel signaling network of a telecommunications network.

As described in Martin U.S. Pat. No. 5,454,034 (hereby incorporated by reference in its entirety), telephone networks, e.g., the Public Switched Telephone Network (PSTN), include a large number of end switching offices serving local subscriber lines and trunks. A smaller number of tandem switching offices provide connections between the end offices. A communication network comprising a large number of analog and digital communication paths interconnects the end offices and tandem offices. A Common Channel Signaling (CCS) network overlaying the communications network comprises Signaling Points (SPs) which include: Service Control Points (SCPs) which are nodes that contain service-related data and service logic, Service Switch Points (SSPs) which are the nodes within switching offices used to selectively establish communication paths, and Signal Transfer Points (STPs) which are nodes at which signaling messages of the CCS are transferred. For purposes of identification in the CCS network, all the SPs are assigned discrete point codes, and subsystem numbers are sometimes assigned to identify a specific user function.

When a call is routed internally within a network, or externally between networks, the call is accompanied by a set of call parameters set in accordance with a standard signaling protocol known as SS7. These call parameters, when set, provide information about the call to the networks. A subset of the SS7 ANSI standard protocol, known as Transaction Capabilities Application Part (TCAP), is commonly used to effect network database queries.

TCAP provides functions that control non-circuit-related information transfer between two or more Signaling Points (SPs). In particular, it allows two SPs to establish a conversation (e.g., TCAP transaction) where queries and responses are exchanged. As an SP supports multiple TCAP transactions simultaneously, unique Transaction Identifications (IDs) are assigned to different transactions. As in interpersonal communication, the meaning of information exchanged within a CCS network depends on its context. For example, when there are multiple questions and responses being communicated between multiple locations, it is not enough to know that the answer is “yes” or “no.” Rather, one needs to correlate the answers with questions to which they are responsive. Transaction IDs serve this purpose.

One simple example of a TCAP-based supplementary service is an 800 call service, as illustrated in Related Art FIG. 1. In this simplified view, a caller at call origin 1 dials an 800 number that must be translated into a routing number recognizable by the PSTN. This translation occurs by triggering SSP 3 to send a TCAP message to supplemental service database 5 of an SCP. An exemplary query message 7 would be:

Provide instructions—Start

Package Type=BEGIN

Component Type=Invoke

Operation=Provide Instructions—Start

Parameters:

Called Party Number 800 234 5678

Calling Party Number 732 949 8939

The database responds with a TCAP message 9 as follows:

Connect Call

Package Type=END

Component Type=Invoke

Operation=Connection Control—Connect

Parameters:

Routing Number 201 444 4323

In the foregoing manner, the dialed 800 number is translated, in database 5, into a routing number that will be recognized by the network. The routing number is then communicated to SSP 3 whereafter it is used to route the call to an intended destination 11.

In more complex implementations, a TCAP-based supplementary service may need to interact with other telecommunication services, i.e., other databases. In this case, the originating node will need to query the TCAP-based supplementary service database, and the TCAP-based supplementary service database (intermediate database) will then interact with another database. In this respect, two current trends in the telecommunication industry can be identified. The first is that service processing logic is migrating from the SSPs to centralized databases. The second is that multiple database queries are often needed when either a customer subscribes to multiple services or when the called and the calling parties both subscribe to services with special features. These trends point to an increasing need for database-to-database communication. Currently, even when the intermediate database is no longer required from a functional standpoint, the intermediate database remains involved to preserve the end-to-end TCAP connectivity between the originating SP and the terminating SP.

A related situation where an intermediate SP is required arises in connection with gateway functionality. Very often, an originating SP needs to access a gateway (for security or other reasons) before access to a database is allowed. In some scenarios, in order to preserve the end-to-end TCAP connectivity, the gateway needs to be involved in the TCAP signaling transaction even after the gateway has fulfilled its gateway function.

In each of the foregoing two scenarios, the continued inclusion of an intermediate SP in a TCAP signaling dialogue needlessly utilizes system resources (increases loads), which can result in delays in network performance.

### SUMMARY OF THE INVENTION

In view of the foregoing, it is a principal object of the present invention to provide a method for improving SP connectivity, whereby an intermediate SP is included in a path of connectivity for only so long as is required to establish service functionality, and wherein a direct link by-passing the intermediate SP is thereafter established.

This and other objects are achieved in accordance with the present invention by a method for providing communication links between signaling points (SPs) in a telecommunications signaling network. A communications link is established between a call origination point and a first SP. A signaling transaction is established between the first SP and a second SP. A signaling transaction is established between the second SP and a third SP of the signaling network, such that connectivity is provided between the first SP and the third SP through the second SP. The second SP communicates to the first SP a wait for instruction message indicating (1) the second SP is terminating a signaling transaction with the first SP and (2) the first SP will be receiving a message from the third SP. The second SP communicates to the third SP a correlate message containing first SP identification information and a unique call identifier. The correlate message further indicates that the second SP is terminating a signaling transaction between the second SP and the third SP, and provides a directive to the third SP to send a message to the first SP containing the call identifier. When the first SP receives the message from the third SP, a new signaling transaction is created between the first SP and the third SP, by-passing the first SP, and linking the call identifier with the new signaling transaction.

In a related aspect, the present invention is embodied in a second method for providing communication links between signaling points (SPs) in a telecommunications signaling network. A communications link is established between a call origination point and a first SP. A first signaling transaction is established between the first SP and a second SP comprising a first database. The second communication link communicates to the second SP a query. A second signaling transaction is established between the second SP and a third SP comprising a second database, upon the second SP determining that the query received from the first SP should be handled by the third SP. The second SP communicates to the first SP a wait for instruction message indicating (1) the second SP is terminating the communication link with the first SP and (2) the first SP will be receiving a message from the third SP. The second SP communicates to the third SP a correlate message containing first SP identification information and a unique call identifier. The correlate message further indicates that the second SP is terminating a signaling transaction between the second SP and the third SP, and provides a directive to the third SP to send a message to the first SP containing the call identifier. When the first SP receives the message from the third SP, a new signaling is created between the first SP and the third SP, by-passing the second SP and linking the call identifier with the new signaling transaction.

The above and other objects, features and advantages of the present invention will be readily apparent and fully understood from the following detailed description of preferred embodiments, taken in connection with the appended drawings.

### BRIEF DESCRIPTION OF THE DRAWINGS

FIG. 1 is a schematic view depicting a Related Art signaling network TCAP linkage for a supplemental service providing a simple 800 number calling functionality.

FIG. 2 is a generalized schematic view of a Related Art linkage of multiple signaling points (SPs) in a signaling network

FIG. 3 is a generalized schematic view of a signaling network linkage as shown in FIG. 2, but after application of a “TC Correlate” function in accordance with the present invention.

FIG. 4 is a simplified schematic representation of a data network (e.g., used for voice communication) interfaced to a voice signaling network database, to which the present invention is applied in a first embodiment.

FIGS. 5 and 6 are simplified schematic representations of a telecommunications network including a signaling network of a supplemental service employing multiple databases, prior to (FIG. 5) and after (FIG. 6) application of the inventive “TC Correlate” functionality of the present invention.

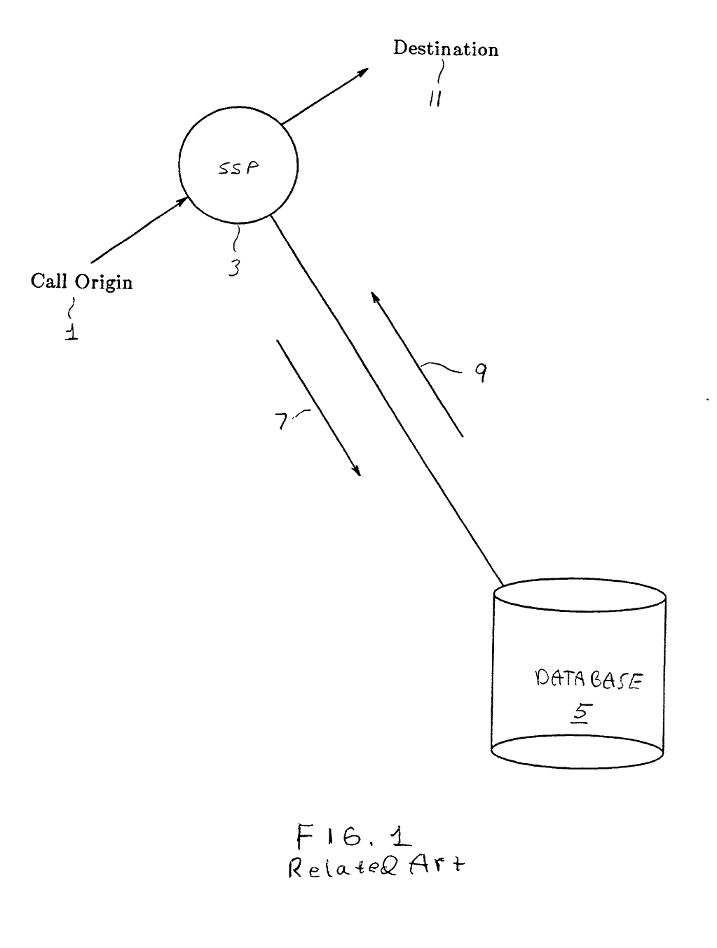

### DETAILED DESCRIPTION OF THE PREFERRED EMBODIMENTS

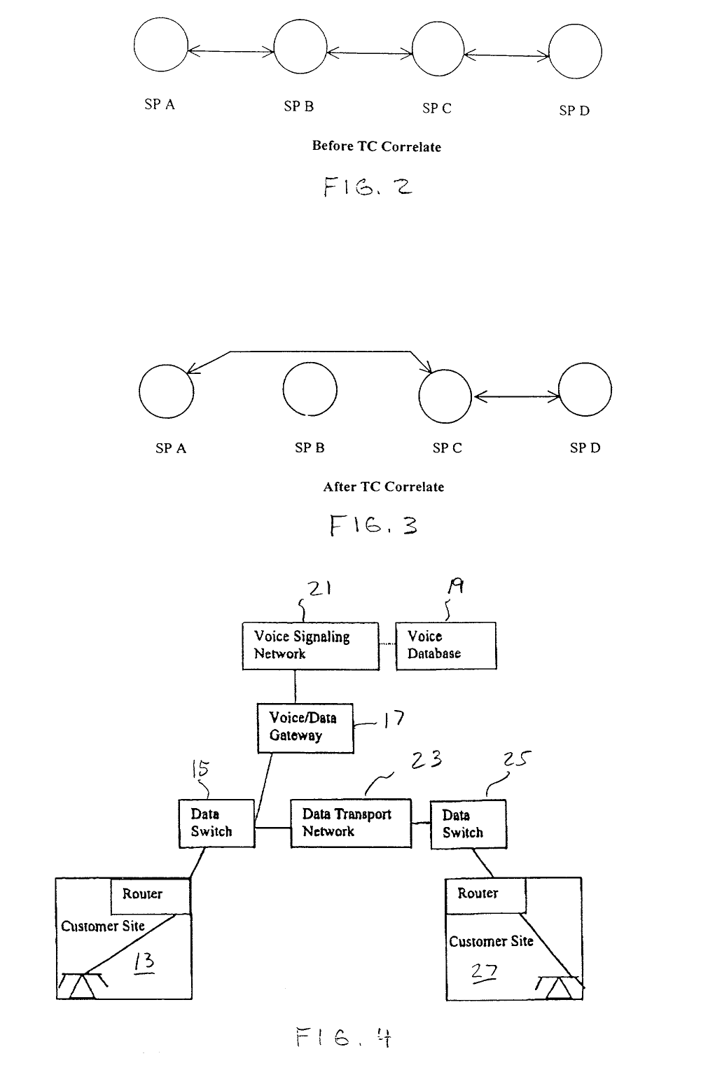

Signaling transactions, e.g., Transaction Capabilities (TCs) in the SS7 protocol, are the functions which provide the means for the transfer of information between signaling points (SPs) via a signaling network. TC Bridging and Forwarding in accordance with the present invention are methodologies for correlating the outgoing TC-dialogue of an originating SP with the outgoing TC-dialogue at an intermediate SP. The methods allow an intermediate SP to be removed from a TC-dialogue while preserving end-to-end TCAP connectivity. As described below with reference to FIGS. 2 and 3, TC Bridging and TC Forwarding preserve end-to-end TCAP connectivity between SP A and SP C, while allowing SP B to end its TC dialogue after it is no longer needed. The SPs which involve the TC Correlate linkage are the node (i.e., SP B) that will terminate the TC dialogue, and the two nodes which have TC dialogue with the terminating node SP B (i.e., SP A and SP C). To all the other SPs, e.g., SP D, the TC Bridging and TC Forwarding procedures are transparent.

An application for TC Forwarding arises when an intermediate SP (i.e., SP B) receives a query from SP A that it recognizes would be better handled by another SP (e.g., SP C comprising a database). In this case, the invention allows SP B to forward the query to SP C and then terminate its TC-dialogue (signaling transaction). The steps for accomplishing this functionality are:

1. SP A sends a query message to SP B.

2. Upon recognizing that SP C would be better to respond to the query, SP B sends a Response message with a specific operation “Wait for Instruction” (which includes SP C's point code and subsystem number) to SP A indicating:

SP B is ending the TC dialogue (signaling transaction) with SP A; and

SP A will be receiving a message from SP C. (The term “message” as used herein refers generally to one or a plurality of data transmissions to provide the required information).

Simultaneously, SP B sends a message to SP C with a specific operation “TC Correlate” which contains SP A's point code and subsystem number and also the originating Transaction ID of SP A to SP B. The specific operation “TC Correlate” indicates that:

SP B is ending the TC dialogue (signaling transaction) with SP C; and

SP C needs to send a message to SP A containing the originating transaction ID of SP A to SP B, and service specific information when appropriate.

3. Upon receiving the message with “TC Correlate” from SP C, SP A will create a new signaling transaction with SP C, by-passing SP B, and will link the retained originating transaction ID with the new signaling transaction.

An exemplary TC Forwarding application corresponding to the generalized methodology just described is to facilitate a gateway functionality between data and voice networks. With the continuing integration of voice and data networks and services, there is an increasing need for data switches to access information from voice network databases. One example of where such a need arises is Private Virtual Network Service using data transport facilities.

Private Virtual Network Service is an existing voice network service which allows the service subscribers to use the PSTN as a private network without dedicated facilities. With Private Virtual Network Service, database query is required to determine routing information and to provide authorization. With recent advances in data network technologies, companies can now carry voice traffic using their data network transport facilities. However, unless the data network can query the voice databases, network providers need to deploy and develop additional databases, corresponding to the voice network databases, in the data network environment.

There are essentially two different ways to allow the data network to access the voice databases. One is to allow the data switch to query the database directly and receive the routing instruction directly from the voice database. This approach has the disadvantage of not being able to leverage use of the existing voice network signaling capability. The second approach is to have a gateway which links the voice and data signaling networks. The TC-Forwarding functionality of the present invention can enhance this second approach.

FIG. 4 shows how the TC-Forwarding application can be used to support Private Virtual Network Service using data transport facilities, by allowing the gateway to forward query information but otherwise stay out of the TC-dialogue. A customer 13 places a call routed to data switch 15. Data switch 15 receives the call and realizes that a voice database query is required. Data switch 15 signals to a voice/data gateway 17 and establishes a TCAP transaction. Gateway 17 sends a Response message with a specific operation “Wait for Instruction” (which include the voice database's signaling address) to data switch 15 indicating that the gateway is ending the TC dialogue with data switch 15, and that data switch 15 will be receiving a message from voice database 19 (associated with a voice signaling network 21) which will contain the originating Transaction ID.

Simultaneously, gateway 17 sends a Query message to voice database 19 with a specific operation “TC Correlate” which contains the data switch address and also the originating Transaction ID of data switch 15 and gateway 17. The specific operation “TC Correlate” indicates that:

Gateway 17 is ending the TC dialogue with voice database 19; and

Voice database 19 needs to send a Query message to data switch 15.

Upon receiving the data switch query, voice database 19 will determine the routing and authorization instructions, which will be sent directly to data switch 15. Assuming the call is authorized, data switch 15 will route the call, through data transport network 23 (and associated additional switches, e.g., 25) to its destination, e.g., a second customer site 27.

The related TC Bridging functionality of the present invention is now described. The steps of TC Bridging, for the generalized case where intermediate SP B is to end its TC dialogue with A and C (as shown in FIG. 3), are as follows:

1. SP B sends a “Wait for Instruction” instruction (which includes SP C's point code and subsystem number) to SP A indicating:

SP B is ending the TC dialogue (signaling transaction) with SP A;

SP A will be receiving a message from SP C.

Simultaneously, SP B sends a Response message to SP C with a specific operation “TC Correlate” which contains SP A's point code and subsystem number, and also a Transaction ID of the originating signaling transaction between SP A and SP B. The specific operation “TC Correlate” indicates that:

SP B is ending the TC dialogue (signaling transaction) with SP C; and

SP C needs to send a message to SP A containing the originating Transaction ID of the signaling transaction between SP A and SP B, and service specific information when appropriate.

2. Upon receiving the Query message with “TC Correlate” from SP C, SP A will create a new signaling transaction with SP C, by-passing SP B, and will link the retained transaction ID with the new signaling transaction.

As in TC Forwarding, TC Bridging is used to preserve end-to-end TCAP connectivity while allowing an intermediate SP (e.g., SP B) to terminate its TC-dialogue.

A TC-Bridging application, corresponding to the generalized example just described, serves to allow more efficient database-to-database communication. FIG. 5 depicts a service that could be offered where the service processing is dependent on both the calling and the called party service subscription data, stored in separate databases. In addition to the separately stored service customer records, the processing logic for the separate services may reside within different databases A, B. One current example would be the interaction between caller ID service subscribed to by a called party 29 and caller ID block service subscribed to by a calling party 31 (although in such an application there are other service interaction resolution techniques that may be more efficient than querying multiple databases).

The interaction process is now described, with reference to FIG. 5. In step 33, calling party 31 (a subscriber to a service which requires authorization and certain processing) places a call (including a request for service). At a certain stage of the call processing within database A (step 35), database A recognizes that the next stage of the service processing should take place in database B, assuming called party 29 has subscribed to a certain feature. Database A thus queries database B, in step 37, and database B sends a response confirming that the called party is subscribed to the particular feature. At this point, database A is no longer needed to process the call. However, without the TC-Bridging functionality of the present invention, database B has to pass its instruction through database A (step 39), since switch 41 does not have the ability to correlate a direct response from database B with the initial query. When interaction with database B is no longer necessary, switch 41 routes the call to called party 29 (step 43).

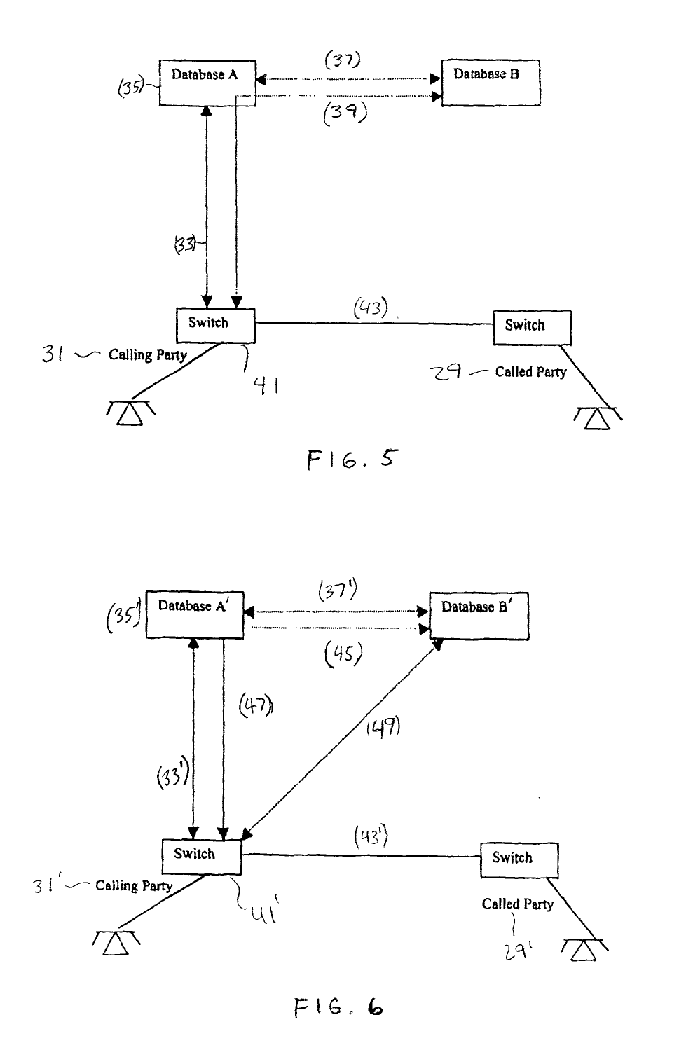

FIG. 6 shows a service as in FIG. 5, but modified to include the TC-Correlate capability of the present invention. In step 33′, calling party 31′, which has subscribed to a service which requires authorization and certain processing, places a call (including a request for service). At a certain stage of the call processing within database A (step 35′), database A realizes that the next stage of the service processing should take place in database B, assuming the called party subscribed to a certain feature. Database A thus queries database B, in step 37′, and database B sends a response confirming that the called party indeed subscribes to the particular feature. At this point, database A is no longer needed to process the call. In accordance with the invention, in steps (links) 45, 47, database A executes the TC-Bridging logic described above in connection with generalized FIGS. 2 and 3. With the TC-Bridging capability, database B (corresponding to SP C) can now communicate directly with switch 41′ (corresponding to SP A) (step 49), by-passing database A′ (corresponding to SP B). When the interaction with database B is no longer necessary, switch 41′ routes the call to the called party 29′ (step 43).

The present invention has been described in terms of preferred and exemplary embodiments thereof Numerous other embodiments, modifications and variations within the scope and spirit of the appended claims will occur to persons of ordinary skill in the art from a review of this disclosure.

1. A method for providing communication links between signaling points (SPs) in a telecommunications signaling network, comprising:
establishing a communications link between a call origination point and a first SP;
establishing a signaling transaction between the first SP and a second SP;
establishing a signaling transaction between said second SP and a third SP such that connectivity is provided between said first SP and said third SP through said second SP;
communicating from said second SP to said first SP a wait for instruction message indicating (1) the second SP is terminating a signaling transaction with the first SP and (2) the first SP will be receiving a message from the third SP; and
communicating from said second SP to said third SP a correlate message containing first SP identification information, and a unique call identifier, said correlate message further indicating that the second SP is terminating a signaling transaction between the second SP and the third SP, and providing a directive to the third SP to send a message to the first SP containing the call identifier;
wherein, when said first SP receives said message from said third SP a new signaling transaction is created between said first SP and said third SP, by-passing said second SP, and linking the call identifier with the new signaling transaction.

2. A method according to claim 1, wherein said second SP comprises a gateway of a supplemental service, and said third SP is a database of said supplemental service.

3. A method according to claim 1, wherein said second SP comprises a first database of a supplemental service, and said third SP comprises a second database of a supplemental service.

4. A method according to claim 1, wherein the signaling transaction between the first SP and the second SP, and the signaling transaction between the second SP and the third SP, each comprises TCAP messages.

5. A method according to claim 1, wherein said first SP comprises a data switch of a data transport network, said second SP comprises a gateway of a voice signaling network, and said third SP comprises a database of said voice signaling network, wherein information from said database is utilized in connection with set-up of a communication link within said data transport network.

6. A method according to claim 5, wherein said communication link within the data transport network comprises a voice communication link.

7. A method according to claim 1, wherein said SP identification information includes a point code and subsystem number of the first SP.

8. A method according to claim 1, wherein said call identifier comprises an originating transaction ID of the signaling transaction between the first SP and the second SP.

9. A method for providing communication links between signaling points (SPs) in a telecommunications signaling network, comprising:
establishing a communications link between a call origination point and a first SP;
establishing a first signaling transaction between the first SP and a second SP comprising a first database, said second communication link communicating to said second SP a query;
establishing a second signaling transaction between said second SP and a third SP comprising a second database, upon said second SP determining that the query received from said first SP should be handled by said third SP;
communicating from said second SP to said first SP a wait for instruction message indicating (1) the second SP is terminating the first signaling transaction with the first SP and (2) the first SP will be receiving a message from the third SP; and
communicating from said second SP to said third SP a correlate message containing first SP identification information, and a unique call identifier, said correlate message further indicating that the second SP is terminating the second signaling transaction between the second SP and the third SP, and providing a directive to the third SP to send a message to the first SP containing the call identifier;
wherein, when said first SP receives said message from said third SP, a new signaling transaction is created between said first SP and said third SP, by-passing said second SP, and linking the call identifier with the new signaling transaction.

10. A method according to claim 9, wherein said first SP identification information includes a point code and subsystem number of the first SP.

11. A method according to claim 9, wherein said call identifier comprises an originating transaction ID of the signaling transaction between the first SP and the second SP.
